(19) United States
(12) Patent Application Publication
(10) Pub. No.: US 2008/0072315 A1
(43) Pub. Date: Mar. 20, 2008

(54) PORTABLE COMPUTER SECURITY DEVICE THAT INCLUDES A HOUSING WITH AN INTEGRATED MAGNIFYING LENS

(75) Inventor: Noah L. Anglin, San Jose, CA (US)

Correspondence Address: SCHWEGMAN, LUNDBERG & WOESSNER, P.A., P.O. BOX 2938, MINNEAPOLIS, MN, 55402, US

(73) Assignee: Secure Computing Corporation

(21) Appl. No.: 11/464,966

(22) Filed: Aug. 16, 2006

(51) Int. Cl. H04L 9/32

(52) U.S. Cl. 726/20

(57) ABSTRACT

The present invention relates to a portable computer security device that includes a housing with an integrated magnifying lens. The portable computer security device is relatively small yet includes an LCD which is readily observed by a user of the portable security device. The portable computer security device includes a housing that incorporates a magnifying lens. The portable computer security device further includes a LCD that is positioned within the housing. The LCD is aligned with the magnifying lens to permit observation of the LCD through the magnifying lens. The portable computer security device further includes an integrated circuit that is positioned within the housing. The integrated circuit generates random numbers for display on the LCD such that the random numbers are used to provide access to a computer system.

### FIELD

The present invention relates to a portable computer security device, and in particular to a portable computer security device that includes a housing with an integrated magnifying lens.

### BACKGROUND

Portable computer security devices are commonly used to provide a point for policy enforcement and reporting as it relates to computer system security. The use of portable computer security devices also permits anywhere, anytime remote access to applications, data and networks.

Most portable security devices are used to provide convenient, secure wireless and wired LAN access for individuals such as employees, contractors and guests. A portable computer security device may serve as a reliable mechanism to enable configuration compliance while ensuring that every end-point device adheres to a security policy.

The endpoint security that is enabled by portable computer security devices ensures that only properly configured end-point devices can access the network. Portable computer security devices serve as a vital component to a complete identity and access management strategy for computing systems.

Manufacturers are constantly trying to make portable computer security devices as small as possible. Many portable computer security devices include a liquid crystal display (hereafter LCD) that is used to provide computer system information to a user. One of the drawbacks with existing portable security devices is that they have become so small it is difficult to read the LCDs which are part of the portable computer security device.

There is a need for a portable computer security device that is relatively small yet includes an LCD which is readily observed by a user of the portable security device. The portable computer security device should incorporate the features, quality and styling of existing portable computer security devices without sacrificing the ability of a user to readily observe an LCD on the portable computer security device.

### SUMMARY OF THE INVENTION

The present invention relates to a portable computer security device that includes a housing with an integrated magnifying lens. The portable computer security device is relatively small yet includes an LCD which is readily observed by a user of the portable security device.

The portable computer security device includes a housing that incorporates a magnifying lens. The portable computer security device further includes a LCD that is positioned within the housing. The LCD is aligned with the magnifying lens to permit observation of the LCD through the magnifying lens.

The portable computer security device further includes an integrated circuit that is positioned within the housing. The integrated circuit generates random numbers for display on the LCD such that the random numbers are used to provide access to a computer system.

In some embodiments, the magnifying lens is a cylindrical lens that is embedded in the housing. As an example, the magnifying lens may be molded into the housing such that the magnifying lens is integral with the housing.

The magnifying lens may focus and/or magnify light from the LCD toward a user of the portable security device. In some embodiments, the magnifying lens may magnify the light from the LCD by as much as 50%.

The purposes and features of the present invention will be set forth in the description that follows. Additional features of the invention may be realized and attained by the product and processes particularly pointed out in the written description and claims hereof as well as from the appended drawings.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the invention.

### BRIEF DESCRIPTION OF THE DRAWINGS

The present invention will be more fully understood, and further features will become apparent, when reference is made to the following detailed description and the accompanying drawings. The drawings are merely representative and are not intended to limit the scope of the claims. Like parts depicted in the drawings are referred to by the same reference numerals.

FIG. 1 is a perspective view of a portable computer security device.

FIG. 2 is an enlarged perspective view illustrating a front side of a cover of that may be used in the portable computer security device shown in FIG. 1.

FIG. 3 is an enlarged perspective view illustrating a back side of the cover shown in FIG. 2 with an LCD positioned within a cavity in the cover.

FIG. 4 is an exploded perspective view from the front side of the cover where the LCD is removed from the back side of the cover.

FIG. 5 is an exploded perspective view from the back side of the cover where the LCD is removed from the back side of the cover.

FIG. 6 is an electrical schematic of an example integrated circuit that may be used in the portable computer security device of FIG. 1.

### DETAILED DESCRIPTION OF THE INVENTION

The following detailed description references the accompanying drawings which show some example embodiments of the invention. These example embodiments are described in sufficient detail to enable those skilled in the art to practice the invention. It is to be understood that other embodiments may be utilized, or structural changes made, such that the detailed description should not be considered as limiting the scope of the claims.

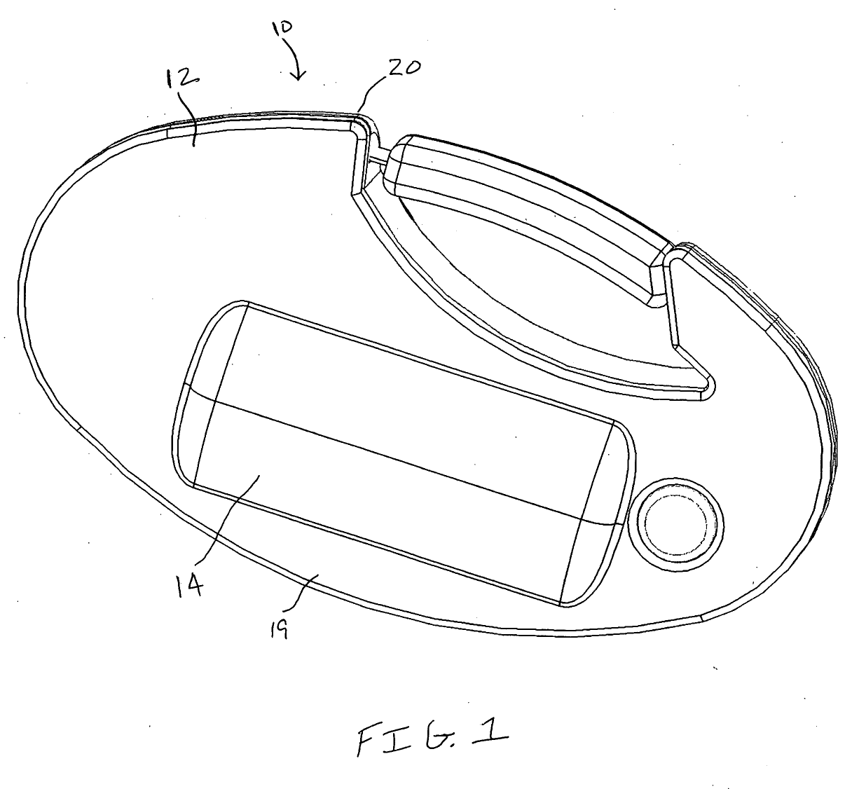

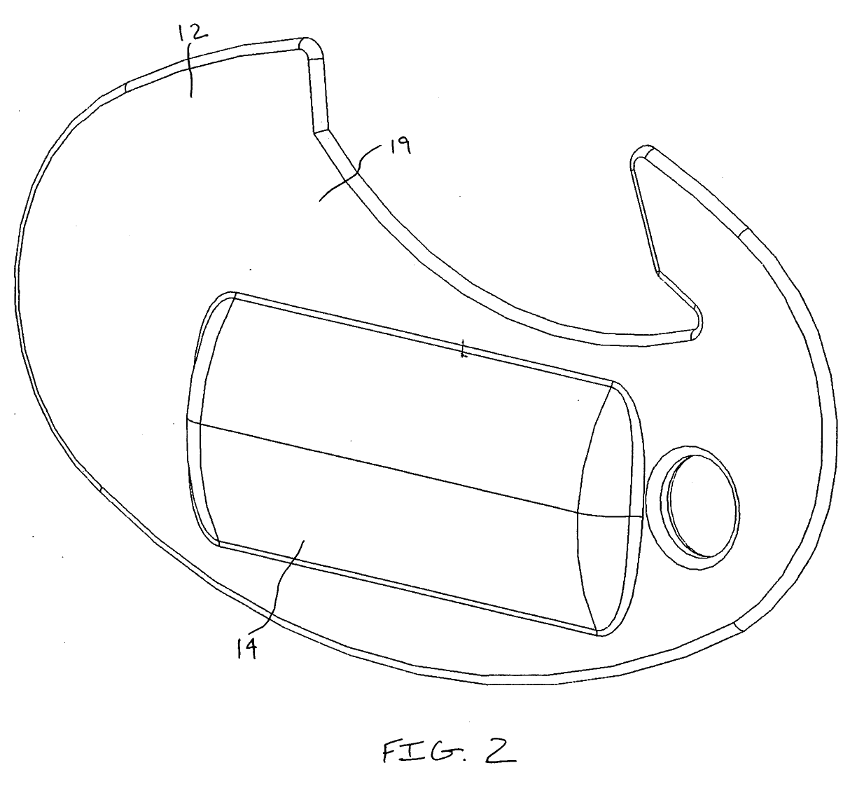

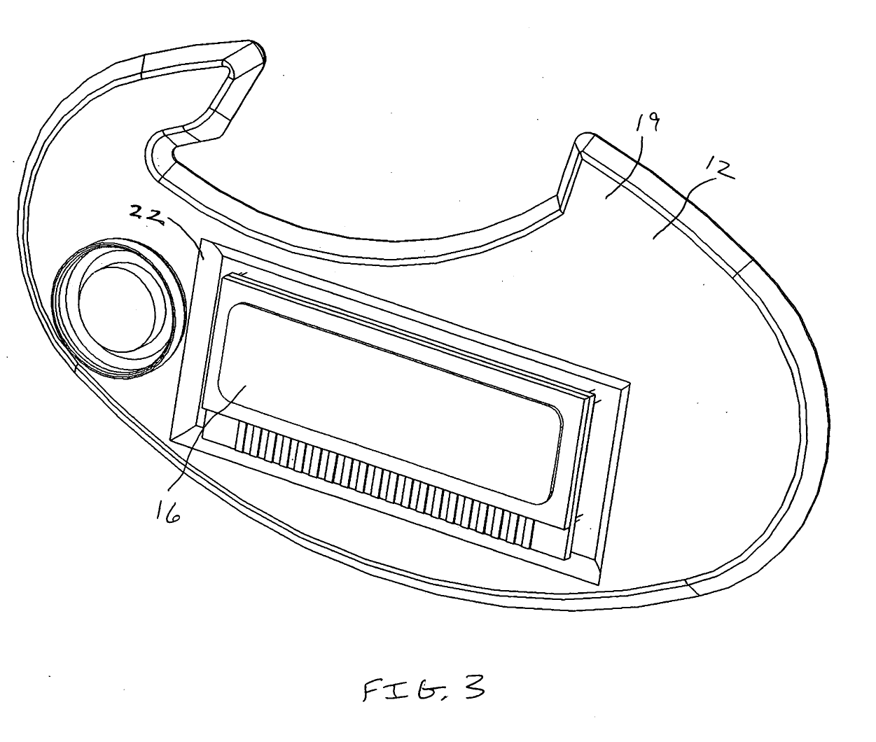

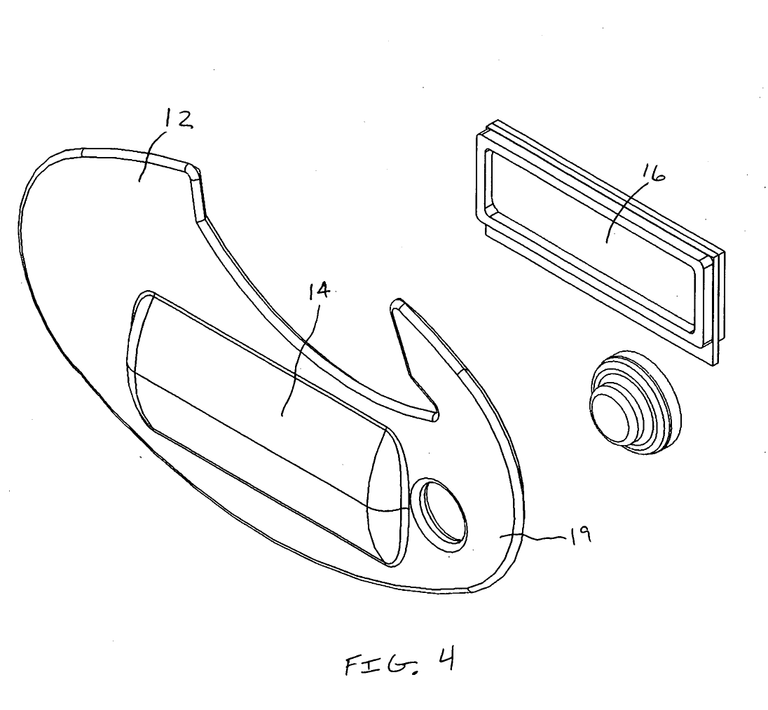

FIGS. 1-5 illustrate an example portable computer security device 10. The portable computer security device 10 includes a housing 12 that incorporates a magnifying lens 14. As shown in FIGS. 3-5, the portable computer security device 10 further includes a LCD 16 positioned within the housing 12 such that the LCD 16 is aligned with the magnifying lens 14 to permit observation of the LCD 16 through the magnifying lens 14.

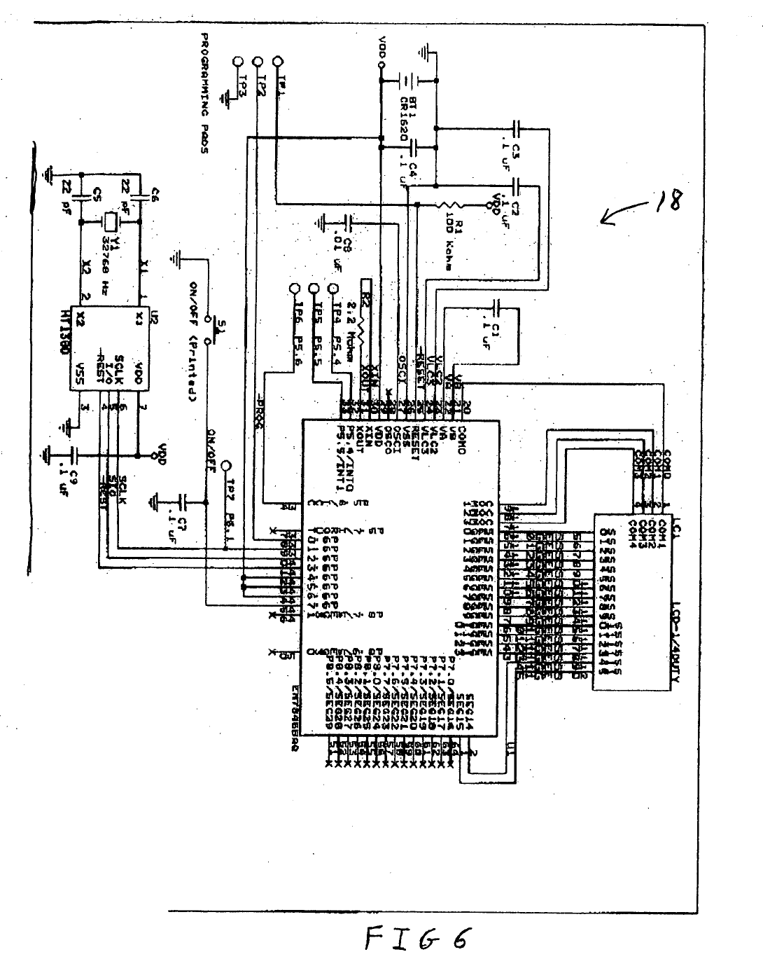

The portable computer security device 10 further includes an integrated circuit 18 (not visible in FIGS. 1-5) that is positioned within the housing 12. An example integrated circuit 18 is shown in FIG. 6. The integrated circuit 18 generates random numbers for display on the LCD 16 such that the random numbers are used to provide access to a computer system. It should be noted that the random numbers may be generated in an event synchronous mode or a timed synchronous mode.

In some embodiments, the magnifying lens 14 is a cylindrical lens that is embedded in the housing 12. As an example, the magnifying lens 14 may be molded into the housing 12 such that the magnifying lens 14 is integral with the housing 12.

The magnifying lens 14 may focus and/or magnify light from the LCD 16 toward a user of the portable security device 10. In some embodiments, the magnifying lens 14 may magnify the light from the LCD 16 by as much as 50%.

It should be noted that the magnifying lens 14 may be attached to the housing 12 in any manner that promotes alignment of the magnifying lens 14 with the LCD 16. The method of attachment between the magnifying lens 14 and the housing 12 will depend in large part on the materials that are used to form the magnifying lens 14 and the housing 12.

In addition, the size and type of magnifying lens 14 will be determined in part based on the degree of magnification that is desired for the LCD 16. As an example, the magnifying lens 14 may have a rectangular shape. Some example materials for the magnifying lens 14 include glass and plastic (e.g., a polycarbonate).

In the illustrated example embodiment, the housing 12 includes a cover 19 and a base 20 (only partially visible in FIG. 1) such that the cover 19 is secured to the base 20 to form the housing 12. Example materials for the cover 19 and the base 20 include metal and plastic.

Although the magnifying lens 14 is shown as being part of the cover 19, it should be noted that embodiments are contemplated where the magnifying lens 14 is part of the base 20. In addition, the LCD 16 may be secured within the cover 19 or base 20 such that the magnifying lens 14 on the cover 19 is aligned with the LCD 16 when the base 20 is secured to the cover 19.

The cover 19 may be attached to the base 20 in any manner that is known now or discovered in the future. As an example, the cover 19 may be secured to the base 20 using an adhesive. The type of attachment between the cover 19 and the base 20 will depend in part on the structural design of the cover 19 and the base 20 (among other factors).

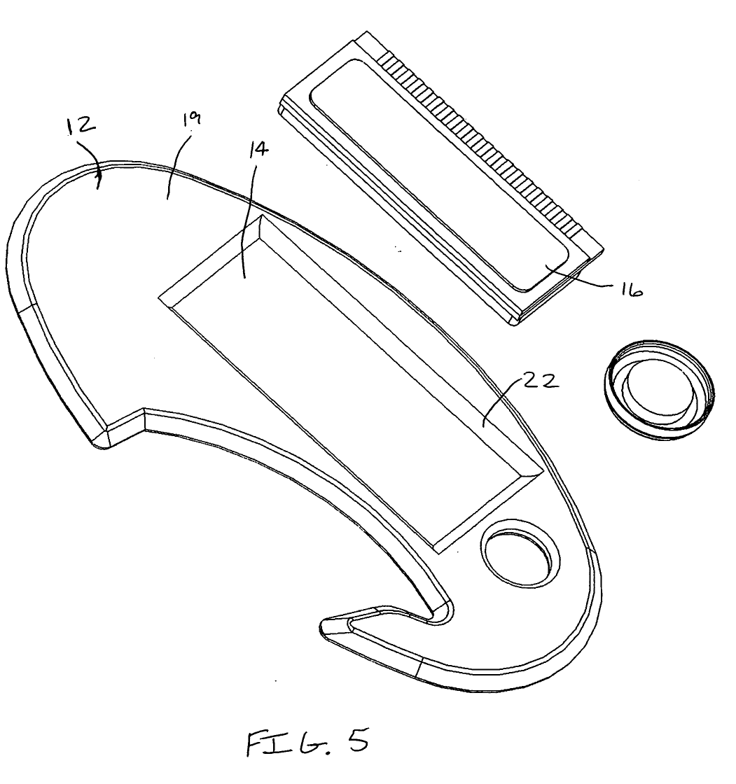

As shown most clearly in FIGS. 3 and 5, the cover 19 may include a cavity 22 such that the LCD 16 is located within the cavity 22 in the cover 19 when the base 20 is secured to the cover 19. In some embodiments, the cavity 22 serves to align the LCD 16 relative to the cover 19 so that the LCD 16 is appropriately positioned relative to the magnifying lens 14.

The size and design of the cavity 22 and the LCD 16 will depend in part on the structural design of the cover 19 and the base 20 (among other factors). As an example, the LCD 16 and the cavity 22 may have a rectangular shape.

The portable computer security devices 10 described herein are relatively small yet include an LCD 16 which is readily observed by users of the portable security devices 10. The ability to readily observe the LCD 16 on the portable computer security devices 10 makes it is easier to utilize the portable computer security devices 10.

While the invention has been described in detail with respect to the specific aspects thereof, it will be appreciated that those skilled in the art, upon attaining an understanding of the foregoing, may readily conceive of alterations to, variations of, and equivalents to these aspects which fall within the spirit and scope of the present invention, which should be assessed accordingly to that of the appended claims.

I claim:

1. A portable computer security device comprising:
a housing that includes a magnifying lens;
a LCD positioned within the housing such that the LCD is aligned with the magnifying lens to permit observation of the LCD through the magnifying lens; and
an integrated circuit within the housing, the integrated circuit generating random numbers for display on the LCD such that the random numbers are used to provide access to a computer system.

2. The portable computer security device of claim 1 wherein the magnifying lens is embedded in the housing.

3. The portable computer security device of claim 1 wherein the magnifying lens is a cylindrical lens.

4. The portable computer security device of claim 1 wherein the housing includes a cover and a base such that the cover is secured to the base to form the housing.

5. The portable computer security device of claim 4 wherein the magnifying lens is part of the cover.

6. The portable computer security device of claim 5 wherein the LCD is secured such that the magnifying lens on the cover is aligned with the LCD when the base is secured to the cover.

7. The portable computer security device of claim 6 wherein the cover includes a cavity such that the LCD is located within the cavity in the cover when the base is secured to the cover.

8. The portable computer security device of claim 7 wherein the LCD has a rectangular shape and the cavity has a rectangular shape.

9. The portable computer security device of claim 8 wherein the magnifying lens has a rectangular shape.

10. The portable computer security device of claim 1 wherein the magnifying lens is molded into the housing.

11. The portable computer security device of claim 1 wherein the magnifying lens is a polycarbonate.
